(19) United States
(12) Patent Application Publication
(10) Pub. No.: US 2005/0244631 A1
(43) Pub. Date: Nov. 3, 2005

(54) Surface protecting film for semiconductor wafer and method of protecting semiconductor wafer using the same

(75) Inventors: Kosuke Sugimoto, Nagoya-shi (JP); Yoshihisa Saimoto, Nagoya-shi (JP); Makoto Kataoka, Sodegaura-shi (JP); Masafumi Miyakawa, Nagoya-shi (JP); Shinichi Hayakawa, Nagoya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUI CHEMICALS, INC., Minato-ku, Tokyo (JP)

(21) Appl. No.: 11/111,721

(22) Filed: Apr. 22, 2005

(30) Foreign Application Priority Data
Apr. 28, 2004 (JP) 2004-132281

(51) Int. Cl. B32B 7/12

(52) U.S. Cl. 428/343; 428/345

(57) ABSTRACT

The present invention is to provide a surface protecting film for a semiconductor wafer which can prevent breakage of the semiconductor wafer even when the semiconductor wafer is thinned to not more than 200 μm, and a method of protecting the semiconductor wafer using the protecting film.

The present invention relates to a surface protecting adhesive film for a semiconductor wafer comprising a base film having an adhesive layer formed on one surface thereof, wherein the base film comprises a layer (A) having a storage elastic modulus of from 1×10⁷ Pa to 1×10⁹ Pa at a temperature range of from 20° C. to 180° C.

### TECHNICAL FIELD

The present invention relates to a surface protecting film for a semiconductor wafer, a method of producing the protecting film and a method of protecting a semiconductor wafer using the protecting film. More particularly, the invention relates to a surface protecting film for a semiconductor wafer and a method of producing the protecting film and a method of protecting a semiconductor wafer using the protecting film which are useful in preventing the breakage of a semiconductor wafer and can enhance the productivity in processing a non-circuit-formed surface of the semiconductor wafer during and after grinding the non-circuit-formed surface of the semiconductor wafer.

### BACKGROUND ART

A step of processing a semiconductor wafer comprises a step of laminating a surface protecting adhesive film for a semiconductor wafer to a circuit-formed surface of the semiconductor wafer, a step of processing a non-circuit-formed surface of the semiconductor wafer, a step of peeling off the surface protecting adhesive film for the semiconductor wafer, a step of dicing for dividing and cutting the semiconductor wafer, a step of die bonding for bonding the divided semiconductor chip to a lead frame, then a step of molding for sealing the semiconductor chip with a resin for protecting the outer portion, and the like.

As a conventional surface protecting film for a semiconductor wafer, an adhesive film coated with an adhesive layer on one surface of a resin film is the main stream. However, with the recent wafer thinning technology, there has been proposed a process to support a semiconductor wafer by an adhesive film without peeling the adhesive film even in grinding and processing a non-circuit-formed surface of the semiconductor wafer from the viewpoints of prevention of breakage of semiconductor wafers and the like (JP2001-372232A and JP2002-012344A). Furthermore, even in a heating process, there has been proposed a process without peeling an adhesive film (JP2002-075942A). Further, in late years, an in-line system has been proposed by instrument makers, which is to carry out a step of grinding a back surface of a wafer, a step of releasing the stress of grinding from the wafer, a step of mounting the processed wafer to a dicing frame and a step of peeling off a tape by one instrument. However, problems in an adhesive film for these heating processes have been pointed out, for example, breakage of a semiconductor wafer, bad handling of a wafer, bad cutting of a tape, bad peeling of a tape and the like greatly caused by the elastic modulus of a base material.

In late years, the thinning of a semiconductor chip has been in high demand, and a chip having a thickness of from about 20 μm to 100 μm has also been required. Accordingly, it has been required to propose a surface protecting film for a semiconductor wafer capable of the high temperature process in a state that the surface of a semiconductor wafer is protected without damaging even the thus-thinned semiconductor wafer, and a method of protecting a semiconductor wafer using the protecting film.

[Patent Document 1] JP2001-372232A

[Patent Document 2] JP2002-012344A

[Patent Document 3] JP2002-075942A

### DISCLOSURE OF THE INVENTION

Under these circumstances, an object of the present invention is to provide a surface protecting film for a semiconductor wafer capable of preventing a semiconductor wafer from breaking even when a thickness of a semiconductor wafer is thinned to as low as 200 μm and is heated to not less than 100° C., a method of producing the protecting film and a method of protecting a semiconductor wafer using the protecting film.

The present inventors have conducted an extensive study and, as a result, have found that a surface protecting film for a semiconductor wafer using a film comprising a layer (A) having a storage elastic modulus of from 1×10⁷ Pa to 1×10⁹ Pa at the temperature range of 20° C. to 180° C. as a base film could solve the above object. Thus, the present invention has been completed.

That is, the first invention of the present invention is a surface protecting adhesive film for a semiconductor wafer comprising a base film having an adhesive layer formed on one surface thereof, wherein the base film comprises a layer (A) having a storage elastic modulus of from 1×10⁷ Pa to 1×10⁹ Pa at a temperature range of from 20° C. to 180° C.

In case the adhesive layer has a storage elastic modulus of at least 1×10⁵ Pa at 150° C. and its thickness is from 3 μm to 300 μm, the adhesive layer fully functions as an adhesive agent under temperature conditions for heating the semiconductor wafer, for example, even at a temperature of about 150° C., after a first step of laminating a protecting adhesive film for a semiconductor wafer to a circuit-formed surface of the semiconductor wafer. Furthermore, after peeling off the protecting adhesive film for a semiconductor wafer from the circuit-formed surface of the wafer (hereinafter referred to as a surface), no contamination on the surface of the semiconductor wafer due to adhesive residue and the like does not occur. Further, such an adhesive layer is a preferred embodiment from the viewpoints of proper cushion properties and the like.

The second invention of the present invention is a method of producing a surface protecting adhesive film for a semiconductor wafer comprising a step of irradiating at least one layer of a base film with an electromagnetic wave and a step of forming an adhesive layer on one surface of the base film.

The third invention of the present invention is a method of protecting a semiconductor wafer comprising a first step of laminating the surface protecting adhesive film for a semiconductor wafer to a circuit-formed surface of the semiconductor wafer via an adhesive layer, a second step of grinding a non-circuit-formed surface of the semiconductor wafer and a third step of processing the non-circuit-formed surface of the semiconductor wafer after grinding.

### BEST MODE FOR CARRYING OUT THE INVENTION

The present invention will be described in more detail below.

The surface protecting film for a semiconductor wafer of the present invention has an adhesive layer formed on one surface of the base film comprising at least one layer of the layer (A) having a storage elastic modulus of from 1×10⁷ Pa to 1×10⁹ Pa and more preferably from 1×10⁷ Pa to 5×10⁸ Pa at a temperature range of from 20° C. to 180° C.

When the storage elastic modulus of base film is less than 1×10⁷ Pa at the above temperature range, there are defects in that the film becomes softened too much, the film becomes tacky or the like in some cases. When the storage elastic modulus exceeds 1×10⁹ Pa, there are defects in that the film becomes hardened too much, making cutting properties of the film inferior, making grindability bad, making cushion properties inferior, making handling of wafers by a robot into a wafer processing apparatus difficult and the like in some cases.

As the layer (A) is partly cross-linked, the gel fraction of not less than 70% and more preferably not less than 80% is preferable from the fact that the film is not tacky even in high temperature.

As a method of forming the layer (A), for example, the base film having a storage elastic modulus of less than 1×10⁷ Pa at 180° C. is manufactured by extrusion molding or the like and then the storage elastic modulus can be in the range of from 1×10⁷ Pa to 1×10⁹ Pa at a temperature range of from 20° C. to 180° C. by an irradiation with an electromagnetic wave or a plasma treatment on the film. After that, a protecting film can be manufactured by forming an adhesive layer on one surface thereof. Furthermore, the base film is manufactured and then the protecting film can be manufactured by an irradiation with an electromagnetic wave or a plasma treatment on the protecting film having an adhesive layer formed on one surface of the base film. When the base film comprises two or more layers, the storage elastic modulus is in the range of from 1×10⁷ Pa to 1×10⁹ Pa at a temperature range of from 20° C. to 180° C. by an irradiation with an electromagnetic wave or a plasma treatment on the film after a film is produced, and the film is laminated to a film which is not subjected to the irradiation with an electromagnetic wave irradiation or the plasma treatment. In this manner, a protecting film can be manufactured.

The thickness of the base film influences on the strength of the film itself and on the prevention of breakage of a wafer in processing a back surface. So, it is preferable to select an appropriate thickness depending on step difference in the wafer surface, existence of bump electrodes and the like. The thickness of the base film is preferably from about 20 μm to 300 μm. When the thickness is too thin, the strength of the film itself is weakened and the adhesive film can not sufficiently follow the projection on the wafer surface thereby causing an insufficient adhesion to the projection and, accordingly, a dimple occurs on the back surface of the wafer corresponding to the projection in grinding the back surface of the wafer in some cases. When the thickness is too thicker, it becomes difficult to manufacture an adhesive film and productivity is affected, thus increasing a production cost in some cases.

As a resin forming the layer (A), there can be exemplified, for example, polyolefin such as polyethylene, an ethylene-vinyl acetate copolymer, an ethylene-alkyl acrylate copolymer (an alkyl group having 1 to 4 carbon atoms), an ethylene-α-olefin copolymer, a propylene-α-olefin copolymer, a polypropylene and the like, polyester such as polyethyleneterephthalate and the like, polyester elastomer, urethane type resins and the like. The layer (A) can be obtained by an irradiation with an electromagnetic wave or a plasma treatment on the film formed by the cast film forming, inflation film forming or the like of these resins.

The electromagnetic wave refers to gamma rays, X-rays, ultraviolet rays, electron beams and the like. Examples of irradiation equipments include Area Beam Type Electron Beam Processing System EBC-300-60 or EBC200-100, Scanning Type Electron Beam Processing System EPS-750 manufactured by NHV Corporation and the like as an electron beam processing system.

As for the irradiation conditions, it is preferable that an acceleration voltage is properly selected depending on the film thickness or the depth desired to be processed. The acceleration voltage is preferably not less than 50 kV. It is preferable that an exposure dose is properly selected depending on physical properties of the film desired to be obtained. The exposure dose is preferably from 50 kGy to 1000 kGy.

When the base film is made of two or more layers, a film to be laminated with the layer (A) is preferably not to be irradiated with an electromagnetic wave. Concrete examples thereof include polyolefin such as polyethylene, an ethylene-vinyl acetate copolymer, an ethylene-alkyl acrylate copolymer (an alkyl group having 1 to 4 carbon atoms), an ethylene-α-olefin copolymer, a propylene-α-olefin copolymer, a polypropylene and the like, polyester such as polyethyleneterephthalate, polyethylenenaphthalate and the like, polyimide, polyetheretherketone, polyether sulfone, polyethylene, polypropylene, urethane, liquid crystal and resin films molded from mixed resins thereof.

The adhesive agent forming the adhesive layer of the surface protecting adhesive film for the semiconductor wafer according to the present invention preferably fully functions as an adhesive agent under temperature conditions for heating the semiconductor wafer, for example, even at a temperature of about 120° C., after the first step of laminating the protecting adhesive film for a semiconductor wafer to a circuit-formed surface of the semiconductor wafer. Specifically, examples thereof include an acrylic adhesive agent, a silicon adhesive agent and the like. The thickness of the adhesive layer is preferably from 3 μm to 300 μm. It is preferable that the adhesive layer does not cause any contamination due to adhesive residue and the like on the surface of the semiconductor wafer after peeling off the protecting adhesive film for the semiconductor wafer away from the circuit-formed surface of the wafer (hereinafter referred to as a surface).

Particularly, it is preferable that the adhesive layer is cross-linked with a cross-linking agent having a reactive functional group, a peroxide, radioactive rays or the like at a high density lest the adhesive strength be increased too much through a heating process after laminating a protecting adhesive film for a semiconductor wafer to the circuit-formed surface of the semiconductor wafer and contamination on the surface of the semiconductor wafer be increased. Furthermore, it is preferable that a bad peeling and any adhesive residue do not occur due to the increase in the adhesive strength during heating even when heat-treated under conditions of a temperature of not less than 150° C. after attaching the protecting adhesive film for the semiconductor wafer to the circuit-formed surface of the semiconductor wafer. To this effect, it is preferable that the adhesive layer has a storage elastic modulus of at least 1×10⁵ Pa at 150° C. The storage elastic modulus is good as high as possible. However, its upper limit is usually about 1×10⁸ Pa.

As a method of forming the adhesive layer having the foregoing characteristics, a method using an acrylic adhesive agent is exemplified. The adhesive layer is formed by using an acrylic adhesive agent which is an emulsion polymerization copolymer containing a (meth)acrylic acid alkyl ester monomer unit, a monomer unit having a functional group capable of reacting with a cross-linking agent and a difunctional monomer unit in specific amounts respectively, and using a solution or an emulsion containing a cross-linking agent having two or more functional groups in a molecule for increasing a cohesive force or adjusting an adhesive strength. In case of using the acrylic adhesive agent in the preparation of a solution, the acrylic adhesive agent is separated from an emulsion prepared by emulsion polymerization through desalting or the like, re-dissolved in a solvent or the like, and used. The acrylic adhesive agent has quite a high molecular weight, and is, in many cases, less dissolved or not dissolved in a solvent. Therefore, in view of the cost as well, it is preferable to use the acrylic adhesive agent in the form of an emulsion as such.

As for the acrylic adhesive agent used in the present invention, there can be exemplified, for example, an acrylic adhesive agent prepared by coploymerrizing of monomer mixture which are an acrylic acid alkyl ester, a methacrylic acid alkyl ester or a mixture thereof as a main monomer (hereinafter referred to also as a monomer (A)) and containing a comonomer having a functional group capable of reacting with a cross-linking agent.

As for the monomer (A), there can be exemplified, for example, an acrylic acid alkyl ester or a methacrylic acid alkyl ester containing an alkyl group having from 1 to 12 carbon atoms (these are generally referred to as a (meth)acrylic acid alkyl ester). Preferable is a (meth)acrylic acid alkyl ester containing an alkyl group having from 1 to 8 carbon atoms. Specifically, there can be exemplified, for example, methyl acrylate, methyl methacrylate, ethyl acrylate, ethyl methacrylate, butyl acrylate, butyl methacrylate, 2-ethylhexyl acrylate or the like. These may be used either singly or in a mixture of two or more. Usually, the amount used of the monomer (A) is preferably in the range of from 10 weight % to 98.9 weight % based on the total amount of all the monomers as raw materials of the adhesive agent. More preferably, it is in the range of from 85 weight % to 95 weight %. By specifying the amount used as the monomer (A) in such a range, a polymer containing from 10 weight % to 98.9 weight %, preferably from 85 weight % to 95 weight % of the (meth)acrylic acid alkyl ester monomer unit (A) can be prepared.

As for the monomer (B) forming the monomer unit (B) having the functional group capable of reacting with a cross-linking agent, there can be exemplified, for example, acrylic acid, methacrylic acid, itaconic acid, mesaconic acid, citraconic acid, fumaric acid, maleic acid, itaconic acid monoalkyl ester, mesaconic acid monoalkyl ester, citraconic acid monoalkyl ester, fumaric acid monoalkyl ester, maleic acid monoalkyl ester, glycidyl acrylate, glycidyl methacrylate, 2-hydroxyethyl acrylate, 2-hydroxyethyl methacrylate, acrylamide, methacrylamide, tertiary-butylaminoethyl acrylate, tertiary-butylaminoethyl methacrylate and the like. Preferable are acrylic acid, methacrylic acid, 2-hydroxylethyl acrylate, 2-hydroxylethyl methacrylate, acrylamide, methacrylamide or the like. One of these may be copolymerized with the main monomer, or two or more thereof may be copolymerized therewith. Generally, it is preferable that the amount used as the monomer (B) having the functional group capable of reacting with a cross-linking agent is in the range of from 1 weight % to 40 weight % based on the total amount of all the monomers as raw materials of the adhesive agent. More preferable amount is in the range of from 1 weight % to 10 weight %. Thus, the polymer having the structural unit (B) with approximately the same composition as the monomer composition can be prepared.

Moreover, in order that the adhesive layer fully functions as an adhesive agent even under temperature conditions at a step of processing a back surface of the semiconductor wafer and at a step of heating after laminating the protecting adhesive film for the semiconductor wafer to the circuit-formed surface of the semiconductor wafer, it is preferable to adjust the adhesive strength or the peeling property. As a method, it is preferable to consider a cross-linking method of a particulate bulk for maintaining a cohesive force of the emulsion particles.

In order that the emulsion particles have a storage elastic modulus of not less than 1×10⁵ Pa under temperature conditions of from 150° C. to 200° C., it is preferable to improve a cross-linking method to maintain a cohesive force by copolymerizing the difunctional monomer (C). As for the monomer to be copolymerized well, there can be exemplified, for example, allyl methacrylate, allyl acrylate, divinylbenzene, vinyl methacrylate, vinyl acrylate or, for example, both ends are a diacrylate or a dimethacrylate and a structure of a main chain is propylene glycol (product names: PDP-200, PDP-400, ADP-200 and ADP-400, manufactured by Nippon Oils and Fats Co., Ltd.), tetramethylene glycol (product names: ADT-250 and ADT-850, manufactured by Nippon Oils and Fats Co., Ltd.) and a mixture thereof (product names: ADET-1800 and ADPT-4000, manufactured by Nippon Oils and Fats Co., Ltd.) and the like.

When the difunctional monomer (C) is emulsion-copolymerized, the amount used thereof is preferably in the range of from 0.1 weight % to 30 weight %, more preferably from 0.1 weight % to 5 weight % based on all the monomers. Thus, a polymer having the structural unit (C) with approximately the same composition as the monomer composition can be prepared.

In addition to the main monomer constituting the adhesive agent and the comonomer having the functional group capable of reacting with a cross-linking agent, a specific comonomer having a property as a surfactant (hereinafter referred to also as a polymerizable surfactant) may be copolymerized. The polymerizable surfactant has a property of being copolymerized with a main monomer and a comonomer, and also serves as an emulsifying agent in emulsion polymerization. In case of using an acrylic adhesive agent prepared by emulsion polymerization using a polymerizable surfactant, contamination on the surface of the semiconductor wafer due to a surfactant does not usually occur. Further, even when slight contamination occurs due to an adhesive layer, it can easily be removed by washing the surface of the semiconductor wafer with water.

As for such a polymerizable surfactant, there can be exemplified, for example, polyoxyethylene nonylphenyl ether with a polymerizable 1-propenyl group introduced in a benzene ring (product names: Aquaron RN-10, Aquaron RN-20, Aquaron RN-30, Aquaron RN-50 and the like, manufactured by Daiichi Kogyo Seiyaku Co., Ltd.), ammonium salt of sulfuric acid ester of polyoxyethylene nonylphenyl ether with a polymerizable 1-propenyl group introduced in a benzene ring (product names: Aquaron HS-10, Aquaron HS-20 and the like, manufactured by Daiichi Kogyo Seiyaku Co., Ltd.), and sulfosuccinic acid diester series having a polymerizable double bond in a molecule (product names: Latemul S-120A, Latemul S-180A and the like, manufactured by Kao Corporation). Further, a monomer having a polymerizable double bond, such as vinyl acetate, acrylonitrile, styrene or the like may be copolymerized as required.

As for the polymerization reaction mechanism of the acrylic adhesive agent, there can be exemplified, for example, radical polymerization, anionic polymerization, cationic polymerization and the like. Considering the production cost of the adhesive agent, the influence of the functional groups of the monomers, the influence of ions on the surface of the semiconductor wafer and the like, the polymerization by radical polymerization is preferable. As for the radical polymerization initiator in the polymerization by the radical polymerization reaction, there can be exemplified, for example, organic peroxides such as benzoyl peroxide, acetyl peroxide, isobutyl peroxide, octanoyl peroxide, di-tertiary-butyl peroxide, di-tertiary-amyl peroxide and the like, inorganic peroxides such as ammonium persulfate, potassium persulfate, sodium persulfate and the like, and azo compounds such as 2,2′-azobisisobutyronitrile, 2,2′-azobis-2-methylbutyronitrile, 4,4′-azobis-4-cyanovaleric acid and the like.

In the polymerization by the emulsion polymerization method, among these radical polymerization initiators, water-soluble inorganic peroxides such as ammonium persulfate, potassium persulfate, sodium persulfate and the like, and also water soluble azo compounds having a carboxyl group in a molecule, such as 4,4′-azobis-4-cyanovaleric acid and the like are preferable. In consideration of the influence of ions on the surface of the semiconductor wafer, ammonium persulfate and azo compounds having a carboxyl group in a molecule, such as 4,4′-azobis-4-cyanovaleric acid and the like are more preferable. Azo compounds having a carboxyl group in a molecule, such as 4,4′-azobis-4-cyanovaleric acid and the like are particularly preferable.

The cross-linking agent having two or more cross-linkable functional groups in a molecule used in the present invention is used to be reacted with the functional group of the acrylic adhesive agent for adjusting an adhesive strength and a cohesive force. As for the cross-linking agents, there can be exemplified, for example, epoxy compounds such as sorbitol polyglycidyl ether, polyglycerol polyglycidyl ether, pentaerythritol polyglycidyl ether, diglycerol polyglycidyl ether, glycerol polyglycidyl ether, neopentylglycol diglycidyl ether, resorcin diglycidyl ether and the like, isocyanate compounds such as tetramethylene diisocyanate, hexamethylene diisocyanate, trimethylolpropane toluene diisocyanate 3-addition product, polyisocyanate and the like, aziridine compounds such as trimethylolpropane-tri-β-aziridinyl propionate, tetramethylolmethane-tri-β-aziridinyl propionate, N,N′-diphenylmethane-4,4′-bis(1-aziridinecarboxyamide), N,N′-hexamethylene-1,6-bis(1-azilidinecarboxyamide), N,N′-toluene-2,4-bis(1-azilidinecarboxyamide), trimethylolpropane-tri-β-(2-methylaziridine) propionate and the like, tetrafunctional epoxy compounds such as N,N,N′,N′-tetraglycidyl-m-xylenediamine, 1,3-bis(N,N′-diglycidylaminomethyl)cyclohexane, and melamine compounds such as hexamethoxymethylolmelamine and the like. These may be used either singly or in a mixture of two or more.

Ordinarily, the content of the cross-linking agent is preferably in such a range that the number of functional groups in the cross-linking agent is not larger than the number of functional groups in the acrylic adhesive agent. However, when a functional group is newly generated in the cross-linking reaction or when the cross-linking reaction proceeds slowly, the cross-linking agent may be contained in a larger amount as required. The preferable content of the cross-linking agent is in the range of from 0.1 weight part to 15 weight parts per 100 weight parts of the acrylic adhesive agent. When the content is too low, sometimes, the cohesive force of the adhesive layer may be insufficient, the elastic modulus may be less than 1×10⁵ Pa at 150° C. and heat resistance may be deteriorated. Accordingly, an adhesive residue due to the adhesive layer tends to occur and the adhesive strength is increased. So, when the protecting adhesive film is peeled away from the surface of the semiconductor wafer, the peeling trouble may occur in an automatic detaping machine and the semiconductor wafer may be completely broken in some cases. When the content is too much, the adhesive strength between the adhesive layer and the surface of the semiconductor wafer is weakened, with the result that a grinding dust may be entered between the surface of the semiconductor wafer and the adhesive layer in the step of backgrinding the semiconductor wafer, and the breakage of the semiconductor wafer or contamination on the surface of the semiconductor wafer may occur in some cases.

The adhesive agent coating solution used in the present invention may properly contain tackifiers for adjusting adhesive properties, such as rosin resins, terpene resins and the like, various surfactants and the like to such an extent that the aim of the present invention is not influenced, in addition to the acrylic adhesive agent prepared by copolymerizing the specific difunctional monomer and the cross-linking agent. Moreover, when the coating solution is an emulsion, film-forming agents such as diethylene glycol monoalkyl ethers and the like may properly be added to such an extent that the aim of the present invention is not influenced. Diethylene glycol monoalkyl ethers and their derivatives used as film-forming agents, when they are present in large amounts in the adhesive layer, might contaminate the surface of the semiconductor wafer to such an extent that washing is impossible. For this reason, it is preferable that materials which are volatilized at a drying temperature of the adhesive agent coating solution are used to minimize the residual amounts of these in the adhesive layer.

The adhesive strength of the protecting adhesive film for the semiconductor wafer in the present invention can be properly adjusted in consideration of the processing conditions of the semiconductor wafer, the diameter of the semiconductor wafer, the thickness of the semiconductor wafer after backgirnding and the like. When the adhesive strength is too low, it is, sometimes, difficult to laminate the protecting adhesive film to the surface of the semiconductor wafer or a protecting property of the protecting adhesive film becomes insufficient, whereby the semiconductor wafer may be broken or the surface of the semiconductor wafer may be contaminated with grinding dusts or the like. Further, when the adhesive strength is too high, a peeling workability might be decreased such that the peeling trouble may occur in an automatic detaping machine when the protecting adhesive film is peeled off from the surface of the semiconductor wafer after processing the back surface of the semiconductor wafer, or the semiconductor wafer might be broken in some cases. Usually, the adhesive strength is in the range of from 5 g/25 mm to 500 g/25 mm, preferably from 10 g/25 mm to 300 g/25 mm in terms of an adhesive strength in regard to an SUS304-BA plate.

As a method of coating the adhesive agent coating solution on one surface of the base film or the liner, known coating methods such as a roll coater method, a reverse roll coater method, a gravure roll method, a bar coating method, a comma coater method, a die coater method or the like can be applied. The conditions for drying the coated adhesive agent are not particularly restricted. Generally, it is preferable to dry the same in a range of from 80° C. to 200° C. for from 10 seconds to 10 minutes. It is more preferable to dry the same at from 80° C. to 170° C. for from 15 seconds to 5 minutes. For satisfactorily promoting the cross-linking reaction of the cross-linking agent and the adhesive agent, the protecting adhesive film may be heated at from 40° C. to 80° C. for from about 5 to 300 hours after the drying of the adhesive agent coating solution is completed. The thickness of the adhesive layer is preferably in the range of from 3 μm to 300 μm.

In a method of producing the semiconductor wafer using the surface protecting film for the semiconductor wafer according to the present invention, a first step of laminating the surface protecting film for the semiconductor wafer to the circuit-formed surface (hereinafter referred to as a surface) of the semiconductor wafer, a second step of backgrinding the non-circuit-formed surface (hereinafter referred to as a back surface) of the semiconductor wafer are carried out in sequence. Subsequently, a third step of laminating an adhesive film for die bonding to the back surface of the semiconductor wafer or processing under high temperature conditions such as metal sputtering or metal alloy is carried out without peeling off the surface protecting film. The remaining steps are not particularly restricted. For example, a method of producing a semiconductor wafer is exemplified in which a step of peeling the protecting adhesive film for the semiconductor wafer, a step of dicing for dividing and cutting the semiconductor wafer, a step of molding for sealing the semiconductor chip with a resin for protecting the outer portion, and the like are carried out in sequence.

As a method of grinding the non-circuit-formed surface in the second step, there can be exemplified, for example, a method of mechanically grinding the back surface of the semiconductor wafer, a wet etching method, a plasma etching method, a polishing method and the like.

The second step sufficiently comprises a mechanical grinding mainly by a grindstone. However, when the semiconductor wafer is further thinned, a step of releasing the stress for removing a damaged layer generated on the back surface of the wafer according to etching or polishing after mechanically grinding the back surface is preferably combined.

For processing in this third step, without peeling off the protecting film, a step of laminating an adhesive film for die bonding, a step of laminating a dicing tape and adhesive film for die bonding-integrated tape or processing under high temperature conditions for sputtering a metal onto the back surface of the semiconductor wafer and then making a metal alloy is carried out. Then, the protecting film is peeled off from the surface of the semiconductor wafer. Furthermore, treatment such as water washing, plasma washing or the like on the surface of the semiconductor wafer may be carried out as required after the protecting film is peeled off.

The thickness of the semiconductor wafer before processing the back surface of wafer is properly determined depending on the diameter, the type or the like of the semiconductor wafer, and the thickness of the semiconductor wafer after processing the back surface of the semiconductor wafer is properly determined depending on the size of a obtained chip, the type of the circuit or the like.

The operation of laminating the protecting film to the surface of the semiconductor wafer is generally conducted by a device denominated as an automatic laminator using a roll-shaped protecting film, though it may be manually laminated in some cases. Examples of the automatic laminator include Model: ATM-1000B, ATM-1100 and TEAM-100 manufactured by Takatori Corp., Model: STL series manufacture by Teikoku Seiki Co., Ltd., Model: DR8500, DR3000 series manufactured by Nitto Seiki Co., Ltd., RAD3500 series manufactured by Lintec Corporation and the like.

As a device used in the step of laminator the adhesive film for die bonding, for example, Model: ATM-8200, DM-800 manufactured by Takatori Corporation and the like can be cited. As the adhesive film for die bonding, an adhesive film for die bonding by coating a surface of a polyester film or polypropylene film with a varnish made of a mixture of a polyimide resin and a thermosetting resin to form an adhesive layer can be cited. At this time, the mixture of the polyimide resin and the thermosetting resin may be sometimes combined with additives as required. The adhesive film for die bonding is heat laminated to the back surface of the semiconductor wafer with a roll to form the semiconductor wafer with the adhesive agent attached thereto.

After the second step and the third step on the back surface of the semiconductor wafer are respectively completed, the protecting film is peeled off from the surface of the semiconductor wafer. A series of these operations may generally be conducted by a device denominated as an automatic detaping machine, though it may be manually detaped in some cases. Examples of such automatic detaping machine include Model: ATRM-2000B and Model: ATRM-2100 manufactured by Takatori Corporation, Model: STP series manufactured by Teikoku Seiki Co., Ltd., Model: HR-8500 series manufactured by Nitto Seiki Co., Ltd. and the like. Further, for improving a detaping property, it is preferable to conduct detaping with heating as required. Moreover, an in-line system for carrying out steps after the step of grinding the non-circuit-formed surface by one instrument line has been proposed.

The tackiness of the surface of the adhesive agent of the protecting film in the present invention can properly be adjusted in consideration of the processing conditions of the semiconductor wafer, the diameter of the semiconductor wafer, the thickness of the semiconductor wafer after grinding the back surface, heating conditions in the third step and the like. When the tackiness is too low, it is, sometimes, difficult to laminate the protecting film to the surface of the semiconductor wafer, and a protecting property of the protecting film becomes insufficient, whereby the semiconductor wafer is broken or the surface of the semiconductor wafer is contaminated with grinding dusts or the like. Further, when the tackiness is too high, a peeling workability might be decreased such that a peeling trouble occurs in an automatic detaping machine in peeling off the protecting film from the surface of the semiconductor wafer after performing the back surface processing of the semiconductor wafer, or the semiconductor wafer might be broken in some cases.

The method of preparing the surface protecting film for the semiconductor wafer and the method of protecting the semiconductor wafer using the protecting film in the present invention are as described above. However, in view of preventing the contamination on the surface of the semiconductor wafer, it is preferable that environments of producing all the raw materials and environments of storing, coating and drying and environments of irradiation with electron beams are maintained so as to comply with cleanliness of class 1000 or less regulated in U.S. Federal Standard 209b.

As for the semiconductor wafer to which the protecting method for the semiconductor wafer in the present invention can be applied, there can be exemplified, for example, a silicon wafer as well as wafers of germanium, gallium-arsenic, gallium-phosphorus, gallium-arsenic-aluminum and the like.

### EXAMPLES

The present invention is now more specifically illustrated below with reference to Examples. However, the present invention is not limited to these Examples. Meanwhile, various properties described in Examples were measured by the following methods.

### 1. Measurement of Various Properties

### 1-1. Measurement of a Adhesive Strength (N/25 mm)

A adhesive strength is measured according to a method regulated in JIS Z-0237-1991 except for conditions defined below. A sample protecting film is laminated to a surface of an SUS304-BA plate of 5 cm×20 cm (regulated in JIS G-4305-1991) via its adhesive layer at 23° C., and allowed to stand for an hour. One end of the sample is held, and the sample is peeled away from the surface of the SUS304-BA plate at a peel angle of 180° and a peel rate of 300 mm/min. At this time, a stress is measured and converted in terms of a width of 25 mm.

### 1-2. Storage Elastic Modulus (Pa)

A sample for measuring a viscoelasticity of a base film of an adhesive film is prepared. The sample is cut in a rectangle of 10 mm (crosswise)×35 mm (lengthwise). A storage elastic modulus is measured at from 20° C. to 200° C. using a dynamic viscoelasticity measuring device (Model: RMS-II, manufactured by Rheometrics Inc.). A measurement frequency is 1 Hz, and a warpage is 0.1%.

A portion of an adhesive layer of an adhesive film is laminated to a thickness of 1 mm to prepare a sample for measuring a viscoelasticity. The sample is cut in a circle having a diameter of 8 mm. A storage elastic modulus is measured at 150° C. and 200° C. using a dynamic viscoelasticity measuring device (Model: RMS-800, manufactured by Rheometrics Inc.). A measurement frequency is 1 Hz, and a warpage is in a range of from 0.1% to 3%.

### 1-3. Gel Fraction of a Base Film

The gel fraction is measured according to JIS K6769. Not less than 0.3 g of a base material of an adhesive film is sampled. The weight of the sample and that of a stainless steel wire mesh comprising the sample are measured. Then, depending on the film materials, a polyolefin is immersed in boiling xylene while a polyester film is immersed in o-chlorophenol for not less than 8 hours. The sample is dried at 90° C. for not less than 8 hours. The weight of the sample after drying is measured.

At this time, the gel fraction is calculated according to the following formula.

$$Gel Fraction ( \% ) = \frac{\begin{matrix}\{ ( Weight of Steel WireMesh ) + \\ ( Weight of Sample before immersing ) \} - \\ ( Weight of Mesh + Sample after immersing )\end{matrix}}{Weight of Sample beofre immersing} \times 100$$

### 1-4. Breakage of a Semiconductor Wafer (Number of Piece)

The number of broken semiconductor wafers in a step of grinding a back surface of a semiconductor wafer, a step of laminating an adhesive film for die bonding, a step of metal sputtering or metal alloy and a step of detaping the protecting film.

### 2. Preparation Examples of a Surface Protecting Film for a Semiconductor Wafer

### 2-1. Example 1

A film (thickness: 195 μm) of an ethylene-vinyl acetate copolymer was irradiated with an electron beam by an Area Beam Type Electron Beam Processing System EBC200-100 manufactured by NHV Corporation with an acceleration voltage of 200 kV and an exposure dose of 200 kGy. The gel fraction (%) of a base film was 0% before irradiation and 85.4% after irradiation. A storage elastic modulus of the base film was 9.0×10⁷ Pa at 20° C. and 1.3×10⁷ Pa at 180° C.

The adhesive protecting film 1 coated with a 20 μm (drying thickness) thick adhesive agent having a storage elastic modulus of 5.5×10⁵ Pa at 150° C. was prepared. The adhesive strength was 1.0 N/25 mm.

### 2-2. Example 2

A film (thickness: 195 μm) of an ethylene-vinyl acetate copolymer was irradiated with an electron beam with an acceleration voltage of 200 kV and an exposure dose of 300 kGy. The gel fraction (%) of a base film was 0% before irradiation and 90.2% after irradiation. A storage elastic modulus of the base film was 1.0×10⁸ Pa at 20° C. and 1.5×10⁷ Pa at 180° C.

The adhesive protecting film 2 coated with a 20 μm (drying thickness) thick adhesive agent having a storage elastic modulus of 5.5×10⁵ Pa at 150° C. was prepared. The adhesive strength was 1.0 N/25 mm.

### 2-3. Example 3

A film (thickness: 195 μm) of an ethylene-vinyl acetate copolymer was irradiated with an electron beam with an acceleration voltage of 200 kV and an exposure dose of 400 kGy. The gel fraction (%) of a base film was 0% before irradiation and 93.0% after irradiation. A storage elastic modulus of the base film was 1.2×10⁸ Pa at 20° C. and 1.6×10⁷ Pa at 180° C.

The adhesive protecting film 3 coated with a 20 μm (drying thickness) thick adhesive agent having a storage elastic modulus of 5.5×10⁵ Pa at 150° C. was prepared. adhesive strength was 1.0 N/25 mm.

### 2-4. Example 4

A film (thickness: 195 μm) of an ethylene-vinyl acetate copolymer was irradiated with an electron beam with an acceleration voltage of 200 kV and an exposure dose of 500 kGy. The gel fraction (%) of a base film was 0% before irradiation and 94.3% after irradiation. A storage elastic modulus of the base film was 1.3×10⁸ Pa at 20° C. and 1.7×10⁷ Pa at 180° C.

The adhesive protecting film 4 coated with a 20 μm (drying thickness) thick adhesive agent having a storage elastic modulus of 5.5×10⁵ Pa at 150° C. was prepared. adhesive strength was 1.0 N/25 mm.

### 2-5. Example 5

A film (thickness: 195 μm) of an ethylene-vinyl acetate copolymer was irradiated with an electron beam with an acceleration voltage of 200 kV and an exposure dose of 500 kGy. The gel fraction (%) of a base film was 0% before irradiation and 94.3% after irradiation. A storage elastic modulus of the base film was 1.3×10⁸ Pa at 20° C. and 1.7×10⁷ Pa at 180° C.

Then, a polyester film (thickness: 50 μm, gel fraction: 0%) was laminated. The adhesive protecting film 5 comprising the polyester surface of the laminated film coated with a 20 μm (drying thickness) thick adhesive agent having a storage elastic modulus of 5.5×10⁵ Pa at 150° C. was prepared. adhesive strength was 0.9 N/25 mm.

### 2-6. Example 6

A film (thickness: 195 μm) of a polyester elastomer (product name: Hytrel 5557, manufactured by Du Pont-Toray Co., Ltd.) has the gel fraction (%) of a base film of 0%. A storage elastic modulus of the base film was 1.0×10⁸ Pa at 20° C. and 2.0×10⁷ Pa at 180° C.

The adhesive protecting film 6 coated with a 20 μm (drying thickness) thick adhesive agent having a storage elastic modulus of 5.5×10⁵ Pa at 150° C. was prepared. adhesive strength was 1.0 N/25 mm.

### 2-7. Comparative Example 1

A film (thickness: 195 μm) of an ethylene-vinyl acetate copolymer was not irradiated with an electron beam. The gel fraction of a base film was 0% and a storage elastic modulus of the base film was 9.0×10⁷ Pa at 20° C., 9.5×10⁶ Pa at 80° C. and it was unmeasurable (due to film fusion) at 180° C.

The adhesive protecting film 7 coated with a 20 μm (drying thickness) thick adhesive agent having a storage elastic modulus of 5.5×10⁵ Pa at 150° C. was prepared. Adhesive strength was 1.0 N/25 mm.

### 2-8. Comparative Example 2

A film (thickness: 195 μm) of an ethylene-vinyl acetate copolymer was irradiated with an electron beam with an acceleration voltage of 200 kV and an exposure dose of 100 kGy. The gel fraction (%) of a base film was 0% before irradiation and 68.6% after irradiation. A storage elastic modulus of the base film was 9.5×10⁷ Pa at 20° C. and 9.0×10⁶ Pa at 180° C.

Then, the adhesive protecting film 8 coated with a 20 μm (drying thickness) thick adhesive agent having a storage elastic modulus of 5.5×10⁵ Pa at 150° C. was prepared. adhesive strength was 1.0 N/25 mm.

### 2-9. Comparative Example 3

A storage elastic modulus of a base film of a polyethyleneterephthalate film (thickness: 100 μm) was 4.0×10⁹ Pa at 20° C. and 1.5×10⁹ Pa at 180° C.

Then, the adhesive protecting film 9 coated with a 20 μm (drying thickness) thick adhesive agent having a storage elastic modulus of 5.5×10⁵ Pa at 150° C. was prepared. adhesive strength was 1.0 N/25 mm.

### 3. Method of Protecting a Semiconductor Wafer

### 3-1. Example 7

Each of adhesive protecting films 1, 2, 3, 4, 5 and 6 was laminated to the whole surface of the circuit-formed surface of 10 pieces of semiconductor silicon wafers (diameter: 8 inches, thickness: 600 μm, depth of a scribe line: 8 μm, and width of a scribe line: 100 μm) comprising an integrated circuit assembled therein. A back surface of a semiconductor wafer was ground until the wafer thickness became 100 μm using a grinding machine (Model: DFG-860, manufactured by Disco Corporation). Then, an adhesive film for die bonding (product name: HIATTACH, manufactured by Hitachi Chemical Co., Ltd.) was laminated to the back surface of the semiconductor wafer at 150° C. (Model: DM-800, manufactured by Takatori Corporation) in a state that the protecting film was attached to the semiconductor wafer. As a result, from 10 pieces of semiconductor wafers with each of protecting films attached thereto, breakage of semiconductor wafers in grinding the back surface and in attaching the adhesive film for die bonding was found nothing for protecting films 1, 2, 3, 4, 5 and 6. In the detaping step of the protecting films (Model: HR8500II, manufactured by Nitto Seiki Co., Ltd.), breakage of semiconductor wafers were not observed. The obtained results are shown in Table 1.

### 3-2. Evaluation of Protecting Films under High Temperature and Vacuum Conditions

Each of adhesive protecting films 1, 2, 3, 4, 5 and 6 was laminated to the whole surface of the circuit-formed surface of 10 pieces of semiconductor silicon wafers (diameter: 8 inches, thickness: 600 μm, depth of a scribe line: 8 μm, and width of a scribe line: 100 μm) comprising an integrated circuit assembled therein. A back surface of a semiconductor wafer was ground until the wafer thickness became 100 μm using a grinding machine (Model: DFG-860, manufactured by Disco Corporation). The semiconductor wafer after backgrinding was conveyed to a vacuum heated drying machine (Model: V-30, manufactured by Toyo Seisakusyo Co., Ltd.) in a state that the protecting film was attached to the semiconductor wafer. The wafer was maintained in vacuum of not more than 1×10⁻⁵ Torr for 10 minutes. Appearance of the protecting film and breakage of the semiconductor wafer were confirmed. Subsequently, while maintaining vacuum of not more than 1×10⁻⁵ Torr, a temperature was increased to 200° C. Appearance of the protecting film and breakage of the semiconductor wafer were confirmed. Under vacuum and high temperature of 200° C. conditions, no bad appearance of the protecting films 1, 2, 3, 4, 5 and 6, and no breakage of semiconductor wafers were confirmed (evaluated as excellent). The results are shown in Table 1.

### 3-3. Comparative Example 4

Each of adhesive protecting films 7,8 and 9 was laminated to the whole surface of the circuit-formed surface of 10 pices of semiconductor silicon wafers (diameter: 8 inches, thickness: 600 μm, depth of a scribe line: 8 μm, and width of a scribe line: 100 μm) comprising an integrated circuit assembled therein. A back surface of a semiconductor wafer was ground until the wafer thickness became 100 μm using a grinding machine (Model: DFG-860, manufactured by Disco Corporation). Then, an adhesive film for die bonding (product name: HIATTACH, manufactured by Hitachi Chemical Co., Ltd.) was laminated to the back surface of the semiconductor wafer at 150° C. (Model: DM-800, manufactured by Takatori Corporation) in a state that the protecting film was attached to the semiconductor wafer. As a result, in a wafer to which the protecting film 9 was attached, 3 pieces of semiconductor wafers were broken after backgrinding surface due to bad cutting of the protecting film. No breakage was confirmed from other wafers to which the protecting films were laminated. Furthermore, in laminating the adhesive film for die boding, no breakage occurred from other wafers to which the protecting film 9 was laminated. However, 10 pieces of semiconductor wafers were broken due to melting of the film in the protecting film 7, while 3 pieces of semiconductor wafers were broken due to melting of the film in the protecting film 8. In a detaping step (Model: HR8500II, manufactured by Nitto Seiki Co., Ltd.) of other unbroken wafer protecting films for wafers, no breakage of semiconductor wafers occurred. The obtained results are shown in Table 1.

### 3-4. Evaluation of Protecting Films under High Temperature and Vacuum Conditions

Each of adhesive protecting films 7, 8 and 9 was laminated to the whole surface of the circuit-formed surface of 10 pieces of semiconductor silicon wafers (diameter: 8 inches, thickness: 600 μm, depth of a scribe line: 8 μm, and width of a scribe line: 100 μm) comprising an integrated circuit assembled therein. A back surface of a semiconductor wafer was ground until the wafer thickness became 100 μm using a grinding machine (Model: DFG-860, manufactured by Disco Corporation). 3 pieces of the wafers with the protecting film 8 attached thereto were broken due to bad cutting of the film after grinding. Then, unbroken wafers were conveyed to a vacuum heated drying machine (Model: V-30, manufactured by Toyo Seisakusyo Co., Ltd.) in a state that the protecting film was attached to the semiconductor wafer. The wafer was maintained in vacuum of not more than 1×10⁻⁵ Torr for 10 minutes. Appearance of the protecting film and breakage of the semiconductor wafer were confirmed. As a result, no bad appearance of the protecting films 7, 8 and 9, and no breakage of semiconductor wafers were confirmed. Subsequently, while maintaining vacuum of not more than 1×10⁻⁵ Torr, a temperature was increased to 200° C. Appearance of the protecting film and breakage of the semiconductor wafer were confirmed. As a result, in the protecting film 7, all of 10 protecting films were observed with floating from wafer surface at a temperature of not less than 100° C. and in the protecting film 8, 5 out of 10 protecting films were observed with floating from wafer surface at a temperature of not less than 100° C., whereas in the protecting film 9, 7 protecting films were observed with floating at a temperature of not less than 100° C. Furthermore, in the protecting films 7 and 8, all of 10 protecting films were observed with floating at 200° C. (evaluated as bad), while in the protecting film 9, 7 protecting films were not observed with floating at 200° C. The results are shown in Table 1.

TABLE 1

| | Adhesive film 1 | Adhesive film 2 | Adhesive film 3 | Adhesive film 4 | Adhesive film 5 |
|---|---|---|---|---|---|
| Resin of base | ethylene-vinyl | ethylene-vinyl | ethylene-vinyl | ethylene-vinyl | ethylene-vinyl |
| Film | acetate | acetate | acetate | acetate | acetate + polyester |
| Film total | 195 | 195 | 195 | 195 | EVA 195 + |
| Thickness [μm] | | | | | polyester 50 |
| Amount of | 200 | 300 | 400 | 500 | 500 |
| Electron Beam | | | | | |
| Irradiated [kGy] | | | | | |
| Base Film Gel | 85.4 | 90.2 | 93.0 | 94.3 | 94.3 |
| Fraction [%] | | | | | |
| Base Film | 9.0 × 10⁷ | 1.0 × 10⁸ | 1.2 × 10⁸ | 1.3 × 10⁸ | 1.3 × 10⁸ |
| Storage Elastic | | | | | |
| Modulus [Pa] at | | | | | |
| 20° C. | | | | | |
| Base Film | 1.3 × 10⁷ | 1.5 × 10⁷ | 1.6 × 10⁷ | 1.7 × 10⁷ | 1.7 × 10⁷ |
| Storage Elastic | | | | | |
| Modulus [Pa] at | | | | | |
| 180° C. | | | | | |
| Adhesive | 20 | 20 | 20 | 20 | 20 |
| Thickness [μm] | | | | | |
| Adhesive | 1.0 | 1.0 | 1.0 | 1.0 | 0.9 |
| strength[N/25 mm] | | | | | |
| Breakage in | 0 | 0 | 0 | 0 | 0 |
| Grinding [No. of | | | | | |
| sheets] | | | | | |
| Breakage in | 0 | 0 | 0 | 0 | 0 |
| laminating | | | | | |
| Adhesive Film for | | | | | |
| Die Bonding [No. | | | | | |
| of sheets] | | | | | |
| Protecting Film | excellent | excellent | excellent | excellent | excellent |
| Appearance | | | | | |
| under Heat | | | | | |
| Resistance and | | | | | |
| Vacuum | | | | | |
| Evaluation | excellent | excellent | excellent | excellent | excellent |

TABLE 2

| | Adhesive film 6 | Adhesive film 7 | Adhesive film 8 | Adhesive film 9 |
|---|---|---|---|---|
| Resin of base | polyester | ethylene-vinyl | ethylene-vinyl | polyethyleneterephthalate |
| Film | elastomer | acetate | acetate | |
| Film total | 195 | 195 | 195 | 100 |
| Thickness [μm] | | | | |
| Amount of | 0 | 0 | 100 | 0 |
| Electron Beam | | | | |
| Irradiated [kGy] | | | | |
| Base Film Gel | 0 | 0 | 68.6 | 0 |
| Fraction [%] | | | | |
| Base Film | 1.0 × 10⁸ | 9.0 × 10⁷ | 9.5 × 10⁷ | 3.0 × 10⁹ |
| Storage Elastic | | | | |
| Modulus [Pa] at | | | | |
| 20° C. | | | | |
| Base | 2.0 × 10⁷ | — | 9.0 × 10⁶ | 1.5 × 10⁹ |
| Film Storage | | | | |
| Elastic | | | | |
| Modulus [Pa] at | | | | |
| 180° C. | | | | |
| Adhesive | 20 | 20 | 20 | 20 |
| Thickness [μm] | | | | |
| Adhesive | 1.0 | 1.0 | 1.0 | 1.0 |
| strength | | | | |
| [N/25 mm] | | | | |
| Breakage in | 0 | 0 | 0 | 3 |
| Grinding [No. of | | | | |
| sheets] | | | | |
| Breakage in | 0 | 10 | 3 | 0 |
| laminating | | | | |
| Adhesive Film | | | | |
| for Die Bonding | | | | |
| [No. of sheets] | | | | |
| Protecting Film | excellent | bad | bad | good |
| Appearance | | | | |
| under Heat | | | | |
| Resistance and | | | | |
| Vacuum | | | | |
| Evaluation | excellent | bad | bad | bad |

### EFFECT OF THE INVENTION

According to the present invention, in a series of protecting methods for a semiconductor wafer using a surface protecting film for the semiconductor wafer using a base film in which a storage elastic modulus for at least one layer of the base film is from 1×10⁷ Pa to 1×10⁹ Pa at a temperature range of from 20° C. to 180° C., breakage of the semiconductor wafer, contamination and the like in a series of steps can be prevented en for a semiconductor wafer in which the thickness of the semiconductor wafer is thinned to not more than 200 μm.

1. A surface protecting adhesive film for a semiconductor wafer comprising a base film having an adhesive layer formed on one surface thereof, wherein the base film comprises a layer (A) having a storage elastic modulus of from 1×10⁷ Pa to 1×10⁹ Pa at a temperature range of from 20° C. to 180° C.

2. The surface protecting adhesive film for a semiconductor wafer according to claim 1, wherein the layer (A) is partly cross-linked so that the gel fraction is not less than 70%.

3. The surface protecting adhesive film for a semiconductor wafer according to claim 1, wherein the layer (A) is partly cross-linked by an irradiation with an electromagnetic wave so that the gel fraction is not less than 70%.

4. The surface protecting adhesive film for a semiconductor wafer according to claim 1, wherein the adhesive layer has a storage elastic modulus of at least 1×10⁵ Pa at 150° C. and its thickness is from 3 μm to 300 μm.

5. The surface protecting adhesive film for a semiconductor wafer according to claim 2, wherein at least one layer of the base film is not irradiated with an electromagnetic wave.

6. A method of producing a surface protecting adhesive film for a semiconductor wafer comprising a step of irradiating at least one layer of a base film with an electromagnetic wave and a step of forming an adhesive layer on one surface of the base film.

7. The method of producing the surface protecting adhesive film for a semiconductor wafer according to claim 6, comprising a step of irradiating at least one layer of a base film with an electron beam to have the gel fraction of not less than 70% and a step of forming an adhesive layer on one surface of the base film.

8. A method of protecting a semiconductor wafer comprising a first step of laminating the surface protecting adhesive film for a semiconductor wafer according to claim 1 to a circuit-formed surface of the semiconductor wafer via an adhesive layer, a second step of grinding a non-circuit-formed surface of the semiconductor wafer and a third step of processing the non-circuit-formed surface of the semiconductor wafer after grinding.

9. The method of protecting a semiconductor wafer according to claim 8, wherein the second step comprises at least one step selected from a mechanical grinding step by a grindstone, a wet etching step, a plasma etching step and a polishing step.

10. The method of protecting a semiconductor wafer according to claim 8, wherein the third step comprises at least one step selected from a step of attaching a die bond film, a step of sputtering a metal and a step of making a metal alloy after sputtering a metal.
